(19) United States
(12) Patent Application Publication
(10) Pub. No.: US 2006/0252442 A1
(43) Pub. Date: Nov. 9, 2006

(54) Method for establishing a PoC connection in a terminal device with a touch-screen display, an application used in the method and a terminal device

(75) Inventor: Mikko Nurmi, Tampere (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/122,489

(22) Filed: May 4, 2005

(51) Int. Cl. H04Q 7/20

(52) U.S. Cl. 455/518; 370/517

(57) ABSTRACT

The invention relates to a method for establishing a PoC connection (Push to talk over Cellular) from a terminal device with a touch-screen display to the terminal device of a receiving target. The identifier of the receiving target is selected from among the identifiers saved in the memory of the transmitting terminal device. In the method according to the invention, the identifiers of the targets are shown on the touch-screen display of the terminal device. The user selects from the identifiers shown on the display the one to which he/she wants to establish a connection. After this, the user opens a PoC connection to the receiving terminal device by touching the selected identifier with a pointing means, such as a stylus. Preferably, only the identifiers of the targets which use a terminal device supporting the PoC service are shown on the touch-screen of the terminal device. The PoC connection can be opened to one terminal device or to a group of terminal devices. The group of the receiving terminal devices is formed by indicating the identifiers belonging to the group from the identifiers shown on the touch-screen display. The group is preferably formed by drawing on the touch-screen display with the pointing means a closed circle, which encircles the identifiers belonging to the group. A common visual marking is attached to the identifiers belonging to the group, whereby the marking becomes a part of the group identifier. The visual marking is preferably a common background colour. The method according to the invention is implemented by an application program loaded in the memory of the terminal device.

The invention relates to a method for establishing a PoC (Push to talk over Cellular) connection from a terminal device with a touch-screen display to the terminal device of a receiving target, in which method the identifier of the receiving target is selected from among the identifiers saved in the memory of the terminal device. The invention also relates to an application program for implementing the method according to the invention and a terminal device.

Many mobile terminal devices operating in cellular networks, such as mobile phones, today provide the possibility of establishing a voice connection to another terminal device by the so-called PoC (Push to talk over cellular) service. The PoC service means a function of a terminal device, which connects the transmitting terminal device immediately to a voice connection to a terminal device or a number of terminal devices selected in advance. The voice connection is opened in a way familiar from radiophones, by pressing a key of the terminal device, and it operates in accordance with the half duplex principle, i.e. the voice connection is open only to one direction at a time. The PoC calls are transmitted from a terminal device to another through a cellular network supporting the VoIP (Voice over Internet Protocol) service, such as a GSM/GPRS cellular network of the second generation, an EDGE, WCDMA or CDMA 2000 network.

In the known PoC solutions, the voice connection is established in such a way that at first, the user of the terminal device selects from the telephone memo of his/her terminal device the name of the person to whom he/she wants to send a voice-message. After this, the user presses a key which opens the PoC connection, whereby a voice connection is established to the receiving terminal device. When the caller speaks to the terminal device, the recipient of the call hears the voice directly from the loudspeaker of his/her terminal device. The voice connection to the receiving terminal device is open as long as the key opening the connection is kept pressed down in the transmitting terminal device.

If the call is wanted to be transmitted to a number of persons simultaneously, the user must form a group of these persons in the telephone memo of his/her terminal device in advance. The group connection is opened in the same way as above, i.e. the user selects the name of the group from the memo and opens the connection by pressing the key that opens the connection. Then the voice of the user is heard in all the terminal devices belonging to the selected group.

In the prior art solutions, establishing a PoC connection requires searching for the contact information of the recipient from the menus of the phone, which considerably slows down the establishing of the connection. Starting a PoC connection is particularly slow when the connection is wanted to be established to a number of receiving terminal devices simultaneously, because then a group must be formed of the recipients of the call before a connection can be established.

It is the objective of the invention to disclose an improved method and application program for establishing a PoC connection, by which the problems related to the prior art can be reduced.

The objectives of the invention are achieved by a method and an application program, which are characterized in what is set forth in the independent claims. Some preferred embodiments of the invention are set forth in the dependent claims.

The invention relates to a method for establishing a PoC (Push to talk over Cellular) connection from a terminal device with a touch-screen display to the terminal device of a receiving target. The identifier of the receiving target is selected from among the identifiers saved in the memory of the transmitting terminal device. The identifier can be, for example, the name or picture of the person or a combination thereof. In the method according to the invention, the identifiers of the targets are shown on the touch-screen display of the terminal device. The user of the terminal device selects the identifier of the target to which he/she wants to establish a PoC connection from among the identifiers shown on the touch-screen display. When the identifier has been selected, the user opens a PoC connection to the terminal device of the receiving target by touching the selected identifier with a pointing means. The pointing means can be e.g. the user's finger or a needle-like pointer, a so-called stylus, belonging to the accessories of the terminal device. The method according to the invention is implemented by an application program loaded in the memory of the terminal device.

In a preferred embodiment of the method according to the invention, only the identifiers of the targets which use a terminal device supporting the PoC service are shown on the touch-screen display of the terminal device.

In another preferred embodiment of the method according to the invention, the PoC connection is opened by touching the identifier with the pointing means for the first time and closed by touching the identifier with the pointing means for the second time, in which case the connection is activated during the time between the first and the second touch.

In a third preferred embodiment of the method according to the invention, the PoC connection is opened by touching the identifier with a pointing means, in which case the connection is activated for as long as the identifier is being touched.

In a fourth preferred embodiment of the method according to the invention, the PoC connection is opened to a target which comprises a group of receiving terminal devices. The group of the receiving terminal devices is formed by indicating the identifiers belonging to the group from among the identifiers shown on the touch-screen display. The group of receiving terminal devices is preferably indicated by drawing on the touch-screen display with the pointing means a closed circle encircling the identifiers belonging to the group.

In a fifth preferred embodiment of the method according to the invention, the identifiers belonging to the group of receiving terminal devices are provided with a common visual marking, whereby the marking becomes a part of the group identifier. The visual marking is preferably a common background colour.

The method according to the invention has the advantage that it significantly speeds up the establishing of the PoC connection, whereby the time needed for opening the connection is shortened.

In addition, the invention has the advantage that it simplifies and facilitates the establishing of a PoC connection, which increases the use of the PoC service as a form of communication.

In the following, the invention will be described in more detail. Reference will be made to the accompanying drawings, in which

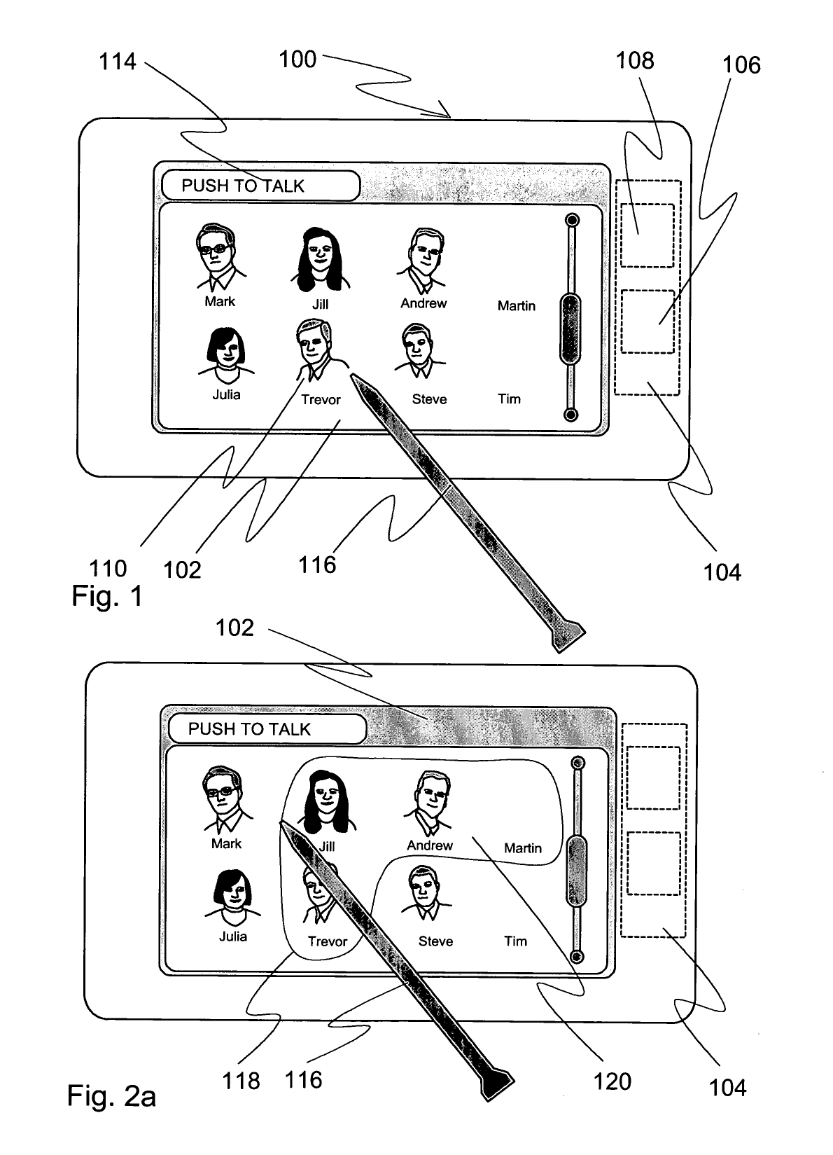

FIG. 1 shows an example of a terminal device operating in a cellular network, by which a PoC connection to another terminal device is established by means of a method and an application program according to the invention, and

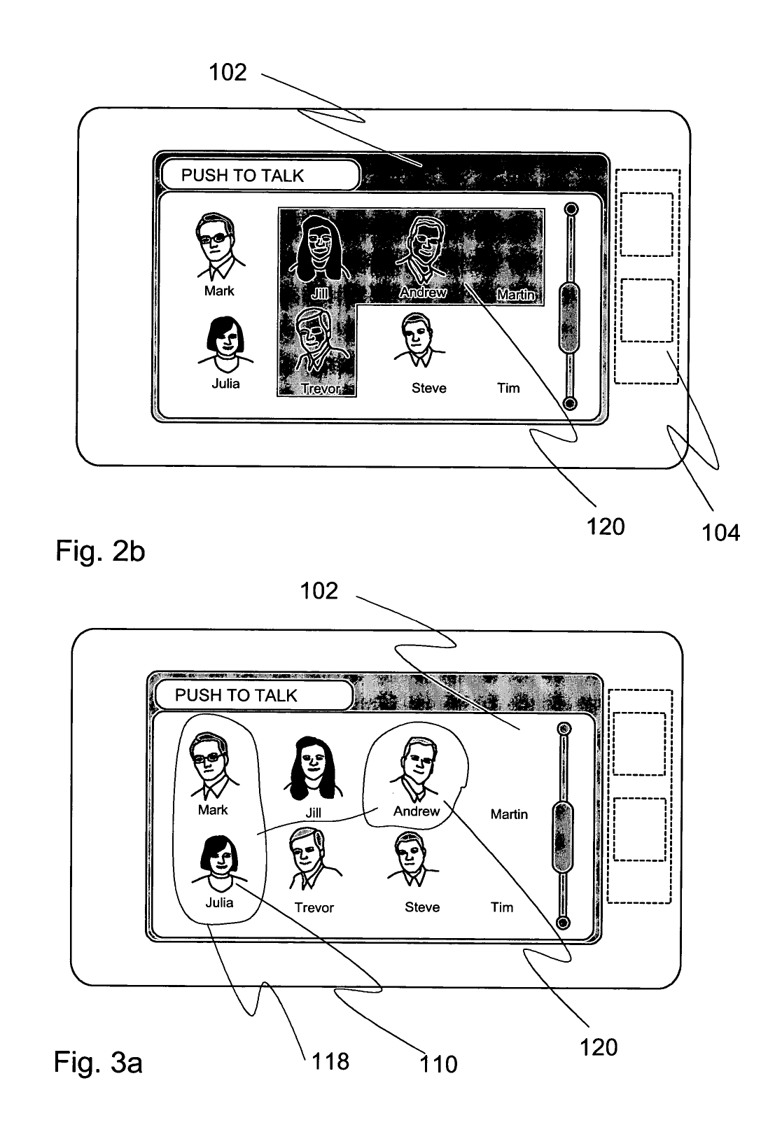

FIGS. 2a and 2b show an example of a terminal device operating in a cellular network, by which a PoC connection to a group of other terminal devices is established by means of a method and an application program according to the invention, and

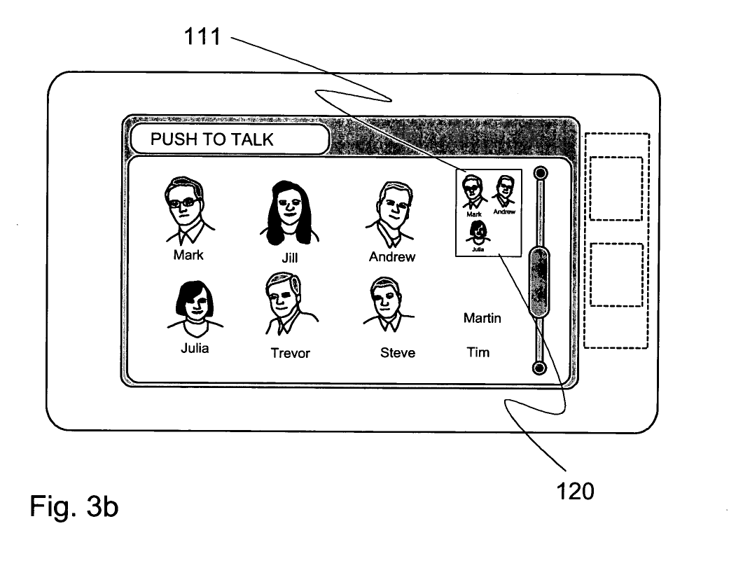

FIGS. 3a and 3b show an example of a preferred embodiment of the method and application program according to the invention for establishing a PoC connection to a group of other terminal devices.

FIG. 1 shows an example of a terminal device 100 operating in a cellular network, such as a mobile phone, in which the method according to the invention for establishing a PoC connection is used. In the PoC connection, the messages are transmitted from a terminal device to another through a cellular network supporting the VoIP (Voice over Internet Protocol) service, such as a GSM/GPRS network of the second generation, an EDGE, WCDMA or CDMA 2000 network. The method according to the invention is suitable for use in terminal devices which are equipped with a so-called touch-screen display. In the terminal device shown in FIG. 1, the touch-screen display is generally denoted by the reference number 102. The method and application program according to the invention especially relate to measures performed on the touch-screen display of the terminal device, and therefore the terminal device is presented with an otherwise simplified structure.

In the known manner, the memory 104 of the terminal device 100 includes a telephone memo 108, into which the user can save the desired telephone numbers. Each telephone number is associated with an identifier 110, which tells to whom the telephone number belongs, i.e. who holds the terminal device to which the telephone number has been given. In general, the identifier used is the name of a person, group, institution or organisation. Many terminal devices today also provide the possibility of using various pictures or combinations of a picture and a name saved in electronic form as identifiers. In the method according to the invention, the identifier is also provided with the information whether the terminal device to which the telephone number belongs supports the PoC service.

For the implementation of the method according to the invention, a special application program 106, by which the PoC connections can be established, has been loaded in the memory 104 of the terminal device 100. When the user of the terminal device wants to open a PoC connection to some target, he/she starts the application program by the menu functions of the terminal device or preferably by a starting icon arranged on the touch-screen display. (The starting icon is not shown in the figure.) As an indication of the starting of the application program, the name of the program 114 appears on the upper edge of the touch-screen display. When the application program has been started, it browses through the identifiers 110 of the targets saved in the telephone memo and finds out whether the identifier is provided with information of the possibility to use a PoC connection. After this, the application program brings to the touch-screen display 102 for viewing by the user of the terminal device all the identifiers associated with telephone numbers belonging to terminal devices which support the PoC service. These identifiers can be names, pictures or combinations thereof, as shown in FIG. 1.

When the user wants to open a PoC connection to a target, he/she simply touches the identifier 110 of this target on the touch-screen display 102 with a pointing means 116. The pointing means can be any suitable means, such as the user's finger or a needle-like means, a so-called stylus, belonging to the accessories of the terminal device. The application program then immediately opens a PoC connection to the terminal device associated with the identifier. The user of the terminal device can now speak his/her message to the microphone of the terminal device, whereby the recipient hears it from the loudspeaker of his/her own terminal device. When the user wants to terminate the PoC connection, he/she touches the same identifier with the pointing means again, whereupon the application program terminates the connection. A function has been arranged in the application program to inform the user when a PoC connection to some target is activated. This function can be implemented in different ways, by changing the background colour of the identifier of the target or by encircling the identifier of the target by a frame, for example. The purpose of the function is naturally to make it easy for the user of the terminal device to see from the display of the terminal device when a PoC connection to a target is activated and when not.

In a preferred embodiment of the invention, the PoC connection is formed by an application program in such a way that the user of the terminal device presses the identifier 110 seen on the touch-screen display 102 during all the time the PoC connection is wanted to be kept activated. When the user wants to terminate the connection, he/she just stops pressing the identifier with the pointing means, whereby the connection is immediately terminated. The PoC connection is thus activated only when the identifier of the target is being pressed. So the mode of operation of this embodiment resembles the traditional mode of operation of radiophones. This embodiment has the special advantage that the PoC connection cannot accidentally remain in the activated status, in which it would prevent hearing the arriving PoC messages.

FIGS. 2a and 2b show how the method and the application program according to the invention are used to establish a PoC connection from one terminal device 100 to a plurality of targets, which use a terminal device supporting the PoC service. When the user wants to establish a PoC connection to more than one targets simultaneously, he/she first forms a group of recipients 120 from the identifiers 110 seen on the touch-screen display 102 of the terminal device. In the method according to the invention, the group of recipients is formed so that the user of the terminal device indicates with a pointing means the identifiers that are wanted to be included in the group being formed. The indicating takes place preferably by drawing on the touch-screen display a closed circle 118, inside which the indicated identifiers remain (FIG. 2a). When the members of the group of recipients 120 have been chosen, the application program attaches a visual marking to the identifiers belonging to the group. This visual marking is preferably a common background colour given to all the identifiers belonging to the group, which clearly differs from the normal background colour of the touch-screen display (FIG. 2b). The common background colour forms on the touch-screen display a clearly distinguishable and easily identifiable bordered area, where the identifiers inside the area belong to the same group. The visual marking becomes a part of the group identifier seen on the touch-screen display, as a result of which the user can point the group merely by touching a point of the visual marking, i.e. any point on the coloured background area.

When the user of the terminal device wants to establish a PoC connection to the group formed, he/she simply touches with a pointing means the identifier of this group, which now consists of single identifiers and a common visual marking, such as the background colour. Then the application program according to the invention opens a PoC connection to all the terminal devices belonging to the chosen group. In practice, a PoC connection established for a group functions in the same way as a connection opened to one target. Keeping the connection activated may require pressing continuously with the pointing means, or the opening and closing of the connection may take place by one short touch, as was described above.

In one preferred embodiment of the invention the common visual marking of the group, such as the coloured background area, forms the identifier of the group and the single identifiers on the coloured background act as identifiers of single targets. When the user of the terminal device wants to establish a PoC connection to the group, he/she touches with a pointing means the common visual marking of this group, and when he/she wants to establish a PoC connection to a single member on the group he/she touches the identifier of the group member.

The group 120 formed on the touch-screen display can also be given a group identifier 111 of its own, and it can be saved in the memory 104 of the terminal device for later use. Then the PoC connection can be opened to the group formed in advance by touching the identifier of this group. Using the same principle it is possible to form a plurality of groups on the display of the terminal device, and a single identifier can belong to a number of different groups.

FIGS. 3a and 3b show a preferred embodiment of the method and application program according to the invention for establishing a PoC connection from one terminal device to a plurality of targets, which use a terminal device supporting the PoC service. Also in this embodiment, the user forms a group of recipients by encircling of the identifiers 110 seen on the touch-screen display 102 the ones that are wanted to be included in the group (FIG. 3a). However, all the identifiers belonging to the group are not bordered within one circle 118, but more than one circles are drawn on the touch-screen display, whereby one or more identifiers 110 remain inside each circle. After this, the user connects the circles by a line drawn on the touch-screen display, whereby the identifiers within all the circles connected together are joined to the group of recipients. This embodiment is useful especially when the identifiers selected to the group are located far from each other on the touch-screen display. When the group of recipients has been formed, it can be given a group identifier 111 of its own. The group identifier is preferably formed by combining single identifiers 110 into one common identifier (FIG. 3b). Then it is seen from the group identifier at once who belong to the group. A group identifier composed of a number of single identifiers can naturally also be used when the group of recipients is formed in the manner described in connection with FIGS. 2a and 2b. Using a group identifier is especially advantageous e.g. when a plurality of different groups are formed on the touch-screen display. Then it may be difficult to distinguish different groups from each other on the basis of the background colour, for example.

The method described above for forming a group 120 of a recipient or recipients in terminal devices with a touch-screen display, operating in cellular networks, is especially suitable for use in establishing a PoC connection between terminal devices. In the same way as the PoC connection, it is also possible to activate a push-to-video or push-to-share function from the terminal device, whereby in addition to or instead of speech, e.g. live video image taken by the transmitting terminal device is sent to the receiving terminal device. However, the method according to the invention for forming a group of recipients of a call can be used as well for opening other data transfer connections, such as ordinary telephone calls from one terminal device to a group of terminal devices.

Some preferred embodiments of the method and application program according to the invention have been described above. The invention is not limited to the solutions described above, but the inventive idea can be applied in numerous ways within the limits set by the claims.

1. A method for establishing a PoC (Push to talk over Cellular) connection from a terminal device with a touch-screen display to the terminal device of a receiving target, in which method the identifier of the receiving target is selected from among the identifiers saved in the memory of the transmitting terminal device, and in which method
the identifiers of the targets are shown on the touch-screen display of the terminal device,
the identifier of the receiving target is selected from the identifiers shown on the touch-screen display, and
the PoC connection is opened to the terminal device of the receiving target by touching the selected identifier with a pointing means.

2. A method according to claim 1, in which only the identifiers of the targets which use a terminal device supporting the PoC service are shown on the touch-screen display.

3. A method according to claim 1, in which the PoC connection is opened by touching the identifier with the pointing means for the first time and closed by touching the identifier with the pointing means for the second time, whereby the connection is activated during the time between the first and the second touch.

4. A method according to claim 1, in which the PoC connection is opened by touching the identifier with the pointing means, whereby the connection is activated for as long as the identifier is being touched.

5. A method according to claim 1, in which the PoC connection is opened to a target comprising one receiving terminal device.

6. A method according to claim 1, in which the PoC connection is opened to a target comprising a group of receiving terminal devices.

7. A method according to claim 6, in which a group of receiving terminal devices is formed by indicating the identifiers belonging to the group from the identifiers shown on the touch-screen display.

8. A method according to claim 7, in which the group of receiving terminal devices is indicated by drawing on the touch-screen display with a pointing means a closed circle encircling the identifiers belonging to the group.

9. A method according to claim 7, in which the group of receiving terminal devices is indicated by drawing on the touch-screen display with a pointing means a plurality of closed circles encircling at least one identifier belonging to the group and by connecting the closed circles with a line.

10. A method according to claim 7, in which a common visual marking is attached to the identifiers belonging to the group, whereby the marking becomes a part of the identifier of the group.

11. A method according to claim 10, in which said visual marking is a common background colour.

12. A method according to claim 7, in which the group of receiving terminal devices is given a group identifier of its own and the group is saved in the memory of the terminal device.

13. A method according to claim 12, in which the group identifier is formed of single identifiers of the targets.

14. An application program for establishing a PoC connection (Push to talk over Cellular) in a terminal device with a touch-screen display, which terminal device has identifiers of the targets receiving the message loaded in its memory, which said application program comprises means for showing the identifiers of the targets on the touch-screen display of the terminal device, and means for opening a PoC connection to the terminal device of the receiving target when the identifier of the target is touched.

15. An application program according to claim 14, which is arranged to show on the touch-screen display only the identifiers of the targets which use a terminal device supporting the PoC service.

16. An application program according to claim 14, which is arranged to open the PoC connection when the identifier is touched for the first time, and to close the PoC connection when the identifier is touched for the second time.

17. An application program according to claim 14, which is arranged to keep the PoC connection activated for as long as the identifier is being touched.

18. An application program according to claim 14, which has means for forming a group of receiving terminal devices from the identifiers shown on the touch-screen display.

19. A terminal device with a touch-screen display, operating in a cellular network, which terminal device has identifiers of the targets receiving the message and an application program for establishing a PoC connection (Push to talk over Cellular) loaded in its memory, which said application program comprises means for showing the identifiers of the targets on the touch-screen display of the terminal device, and means for opening a PoC connection to the terminal device of the receiving target when the identifier of the target is touched.

20. A terminal device according to claim 19, in which said application program comprises means for forming a group of receiving terminal devices from the identifiers shown on the touch-screen display.

21. A computer program on a storage or data transfer means for loading an application program into the memory of a terminal device with a touch-screen display for establishing a PoC connection (Push to talk over Cellular), which said application program comprises means for showing the identifiers of the targets on the touch-screen display of the terminal device, and means for opening a PoC connection to the terminal device of the receiving target when the identifier of the target is touched.

22. A computer program according to claim 21, in which said application program comprises means for forming a group of receiving terminal devices from the identifiers shown on the touch-screen display.
